(19) United States
(12) Patent Application Publication
(10) Pub. No.: US 2013/0269257 A1
(43) Pub. Date: Oct. 17, 2013

(54) WINDOW SECURITY BAR SYSTEM AND ASSEMBLY

(71) Applicant: CARL GERHARD GRUNBICHLER, CORAL SPRINGS, FL (US)

(72) Inventor: CARL GERHARD GRUNBICHLER, CORAL SPRINGS, FL (US)

(21) Appl. No.: 13/448,730

(22) Filed: Apr. 17, 2012

(51) Int. Cl. E06B 9/01

(52) U.S. Cl. 49/50; 49/506

(57) ABSTRACT

A security bar assembly for a window, wherein the security bars are slideably received within the window sash, itself, provides for improved security and aesthetics. More particularly, the bars are slideably received within a channel formed or made in the divider or muntins of the sash such that, when the window is closed, the bars are not visible to an observer on either side of the window. The security bar assembly can remain closed within the window frame, even when the associated window sash has been opened. Optionally, the security bar assembly can also slide within the window frame, to provide a clear path through the window frame, in case of an emergency.

### BACKGROUND OF THE INVENTION

1. Field of the Invention

The present invention relates to a window security bar system, and more particularly, to a window security bar system wherein the bars of the assembly are received within the window sash, itself, to provide for both improved security and greater aesthetics.

2. Description of the Related Art

Traditionally, security bars or “burglar” bars have been used on the inside or outside of a window frame to protect a home against a break-in. See, for example, U.S. Pat. No. 4,452,011 to Trombettas and U.S. Pat. No. 1,855,865 to McWane. As shown more particularly in the exemplary FIG. 1, prior art windows 10 included an assembly of security bars 20 superimposed over the window frame and/or the sash windows 12, 14. Such security bar assembly 20 can be fixed either inside or outside of a building. However, such security bars are unattractive, and mar the appearance of the building and the view seen from the window.

People have tried to address the problem of the unattractiveness of security bars by incorporating the security bars into the window design. For example, U.S. Pat. No. 3,918,202 to Smith discloses window guards including one or more metal bars that extend across the pane on the inside of the window from different points to different points on the frame and are attached to the frame at each point. In Smith, the bars carry wood panes to present the appearance of mullions. U.S. Pat. No. 4,587,759 to Gray discloses a reinforced locking security bar assembly including a rectangular reinforcing bar structure that aligns with the rails and stiles of a window sash. In Gray, two sash halves are joined together around the reinforcing assembly, and thus, a window sash of conventional appearance, but containing rigid metallic reinforcing elements is provided. In both Smith and Gray, the bars become part of the window sash assembly, and cannot be raised and lowered separately from the window sash assembly. Thus, when the window sash is raised or opened, the security bars do not prevent entry through the window opening.

What is needed is a window security bar assembly that does not overlay a window to mar the appearance of a building or a view through the window. What is further needed is a window security bar assembly that can be raised or lowered independently of the sash.

### SUMMARY OF THE INVENTION

A security bar assembly for a window is provided.

At least a portion of each security bar is aligned to be received within a divider of the window sash. In one particular embodiment of the invention, a plurality of security bars are secured to a base. Each of the plurality of bars is slideably received within a channel of the window divider.

Other features which are considered as characteristic for the invention are set forth in the drawings and the appended claims.

Although the invention is illustrated and described herein as embodied in a window security bar assembly, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

For a fuller understanding of the nature of the present invention, reference should be made to the following detailed description, taken in connection with the accompanying drawings, in which like reference numbers represent like items. More particularly:

FIG. 1 is a front plan view of a window superimposed with security bars, as is known in the prior art;

FIG. 2A is a front plan view of a window including a security bar assembly in accordance with one particular embodiment of the invention;

FIG. 2B is a front plan view of the window and security bar assembly of FIG. 2A, wherein one sash is raised, while the security bar assembly remains lowered;

FIG. 2C is a front plan view of the window and security bar assembly of FIG. 2A, wherein a sash and window security bar assembly are both raised;

FIG. 3A is a front plan view of a window including a security bar assembly in accordance with another particular embodiment of the invention;

FIG. 3B is a front plan view of the window and security bar assembly of FIG. 3A, wherein both sashes have been opened, while the security bar assemblies remains closed;

FIG. 3C is a front plan view of the window and security bar assembly of FIG. 3A, wherein both sashes and both window security bar assemblies have been opened;

FIG. 4 is an exploded view of a sash and window security bar assembly in accordance with one particular embodiment of the invention; and

FIG. 4A is a sectional view of the window sash taken along the section line 4A-4A in FIG. 4.

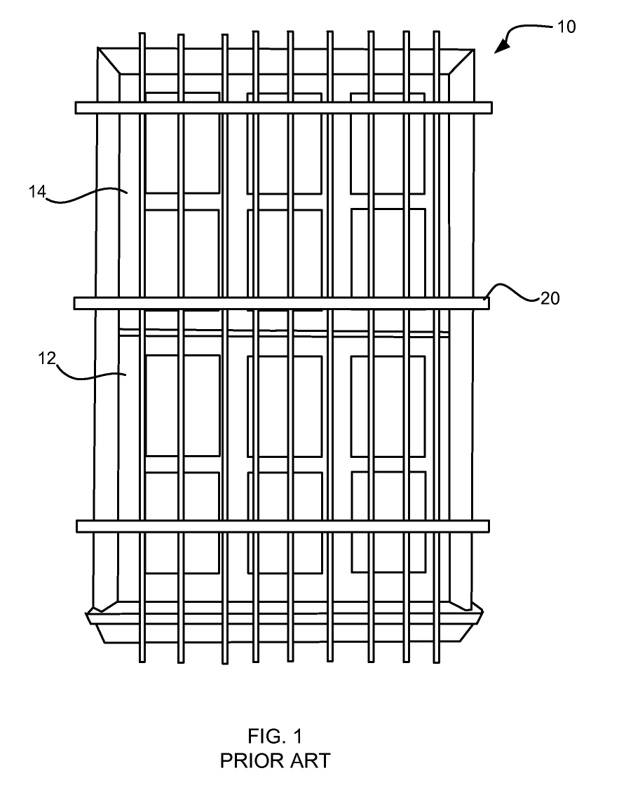

### DETAILED DESCRIPTION OF THE PREFERRED EMBODIMENT

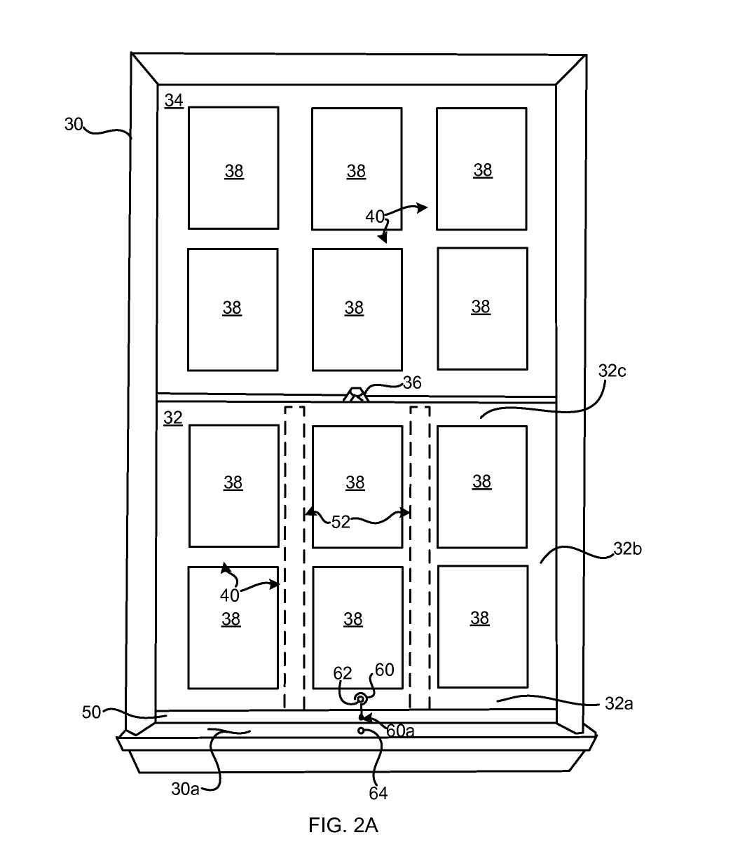

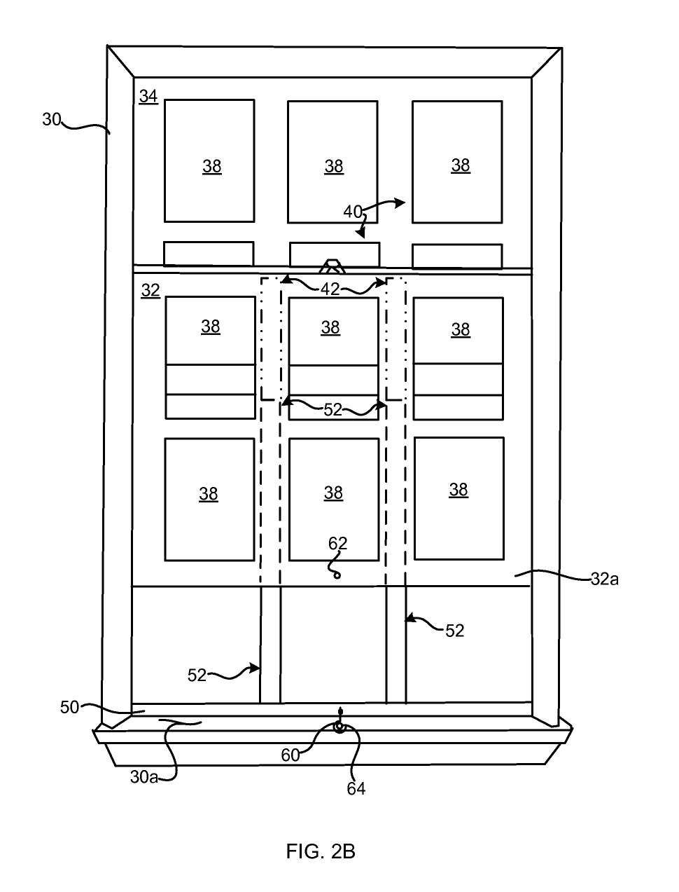

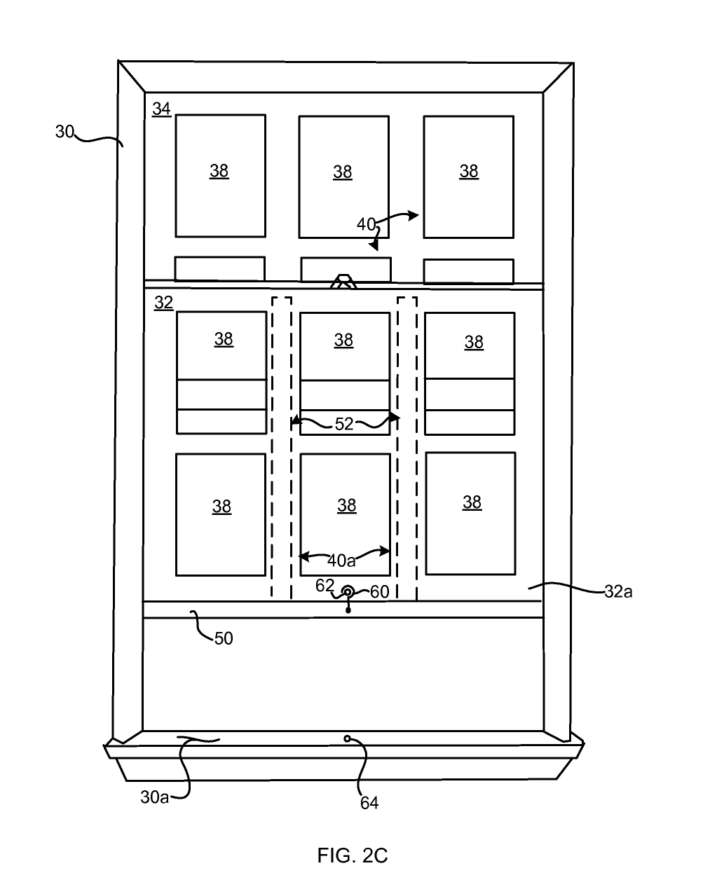

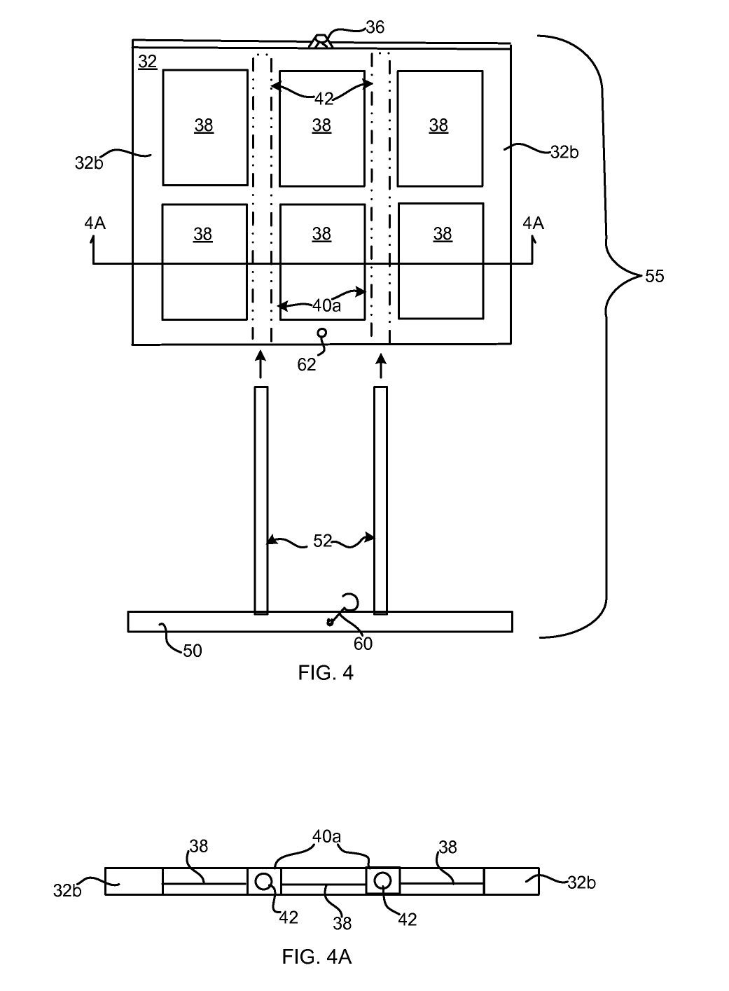

Referring now to FIGS. 2A-2C, 4 and 4A, there is shown a window security bar system and assembly, in which security bars 52 are slideably received within the window sash 32, itself, to provide improved security and aesthetics, and/or structural reinforcement for the windows. In particular, in the preferred embodiment of the invention, the bars 52 are slideably received within a channel 42 (i.e., preferably, coaxially within the channel 42) formed or made in the divider or muntins 40 of the window sash 32 such that, when the window is closed, the bars 52 are not visible to an observer on either side of the window. The security bar assembly can remain closed within the window frame 30, even when the associated window sash 32 has been opened (see, for example, FIG. 2B). In this case, the window sash slides over the stationary bars, as the window is raised. Optionally, the security bar assembly can also slide within the window frame 30, to provide a clear path through the window frame 30, in case of an emergency (see, for example, FIG. 2C).

More particularly, a window frame or casement 30 includes two window sashes 32, 34 received therein. One or both of the window sashes 32, 34 may slide, as desired. As is conventionally known, a sash lock or catch 36 can be used to lock the sashes 32, 34 in the closed position relative to one another. Each of the window sashes 32, 34 of the present embodiment is provided with a plurality of glass panes or “lights” 38, which are held in place by horizontal and vertical dividers or muntins 40. The muntins 40 are received between the rails and stiles of the sash, for example, between the rails 32a, 32c and stiles 32b of the lower sash 32.

In accordance with the present invention, a security bar assembly 55 is provided that includes security bars 52 secured to a base 50, as shown more particularly in FIG. 4. each of the bars 52 is received within a channel 42 made within a subset of the muntins 40. For example, in the present embodiment, the window illustrated is a double hung sash window, which is opened by sliding one or more of the sashes 32, 34 vertically up or down. In one particular embodiment of the invention, the channels 42 have a circular cross-section slightly larger in size than the circular cross-section of the cylindrical bars 52, so as to help maintain the alignment of the bars within the channels. In another embodiment, the channels 42 can be made square or rectangular, as desired. Thus, the bars 52 are arranged to be received in channels 42 made in the vertical muntins 40a of the lower sash 32. Please note that the invention is not meant to be limited solely to use with vertically sliding sash windows. Rather, it should be understood that the principles of the invention can also be applied to horizontally sliding sash windows, if desired. Additionally, although only two security bars 52 are shown in connection with the security bar assembly 55 of the instant embodiment, more bars, or fewer bars, may be provided without deviating from the scope of the present invention.

Referring back to FIGS. 2A-2C, 4 and 4A, there is shown a first embodiment of the invention, wherein the security bar assembly 55 is provided only in connection with the lower sash. As described above, the security bar assembly 55 is integrated with the lower sash 32, such that the bars 52 are slideably received within the channels 42 of the vertical muntins 40a. The length of the security bars 52 can be chosen to ensure that the bars 52 are still received in the channels 42, when the base 50 is latched to the window sill 30a and the lower sash 32 is in its uppermost raised position. In the present preferred embodiment, the channels are blind channels formed or made in the muntins 40, to which access is provided by holes formed through the bottom face of the lower rail 32a. Additionally, the base 50 is, preferably, the same length as the adjacent end of the window frame, so as to not leave a gap between the base and the casement on either side of the base.

In the closed position, the lower sash 32 may be locked relative to the upper sash 34 by locking the catch 36, with the bars 52 received inside the channels 42 of the vertical muntins 40a, with the base 50 sitting between the lower rail 32a of the lower sash 32 and the window sill 30a of the casement 30. In this configuration, shown more particularly in FIG. 2A, the bars 52 are completely hidden from view by an observer located on either side of the window.

If desired, as shown more particularly in FIGS. 2A-2C and 4, a latch 60 may be provided to secure the window security bar assembly 55 to one of the lower sash 32 or the sill 30a. For example, the latch 60 can engage a mating part 62, such as an eyelet or projection on the rail 32a of the lower sash to secure the security bar assembly to the lower sash 32. In this configuration, raising of the lower sash 32 will also raise the security bar assembly 55 secured thereto by the latch 60 and mating part 62, as shown more particularly in FIG. 2C. Thus, in the present embodiment, the security bar assembly can be moved to prevent an occupant from being trapped inside by the security bars 52 in an emergency.

Similarly, the latch 60 can be engaged with a mating part 64 on the window sill 32a, as shown more particularly in FIG. 2B, to secure the security bar assembly 55 in a closed position, even when the lower sash 32 is raised. In such a position, the lower sash may be opened, but the security bar assembly is still locked in place against the window sill 30a, thus preventing entry through the window opening. Only at this time can the bars 52 be seen from inside or outside of the structure.

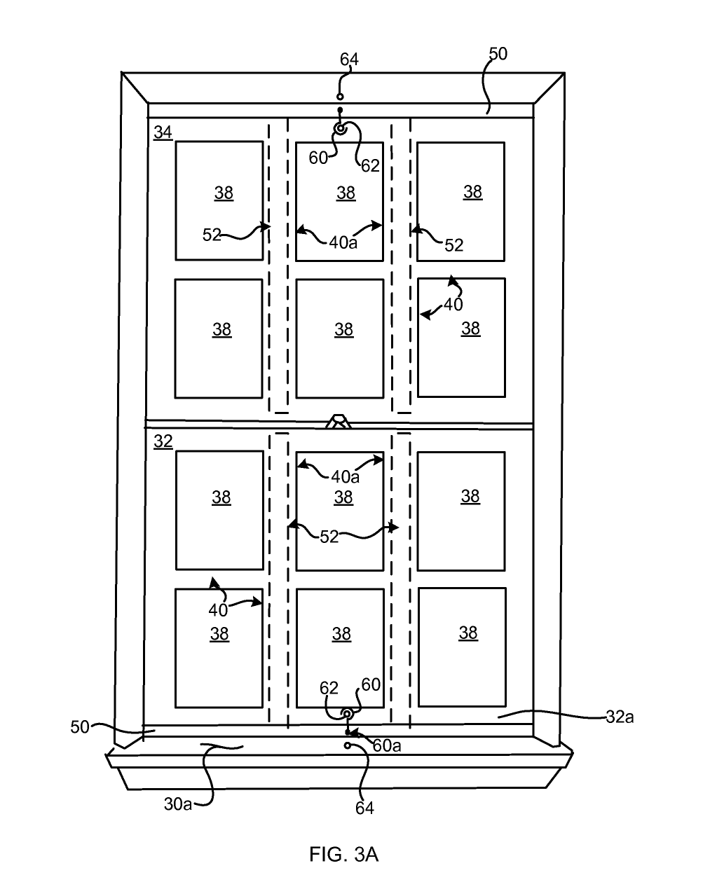

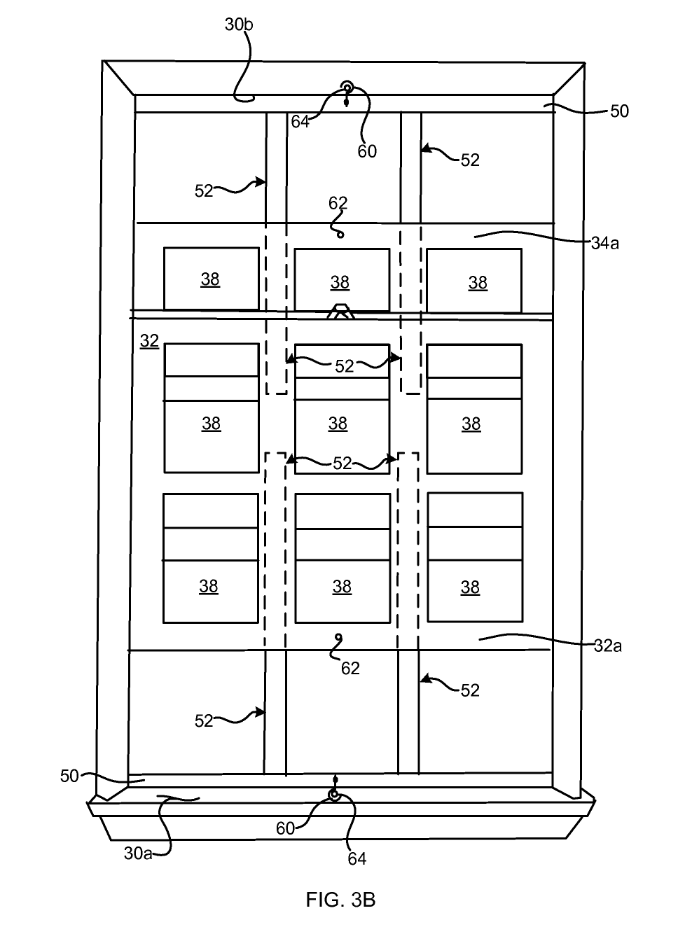

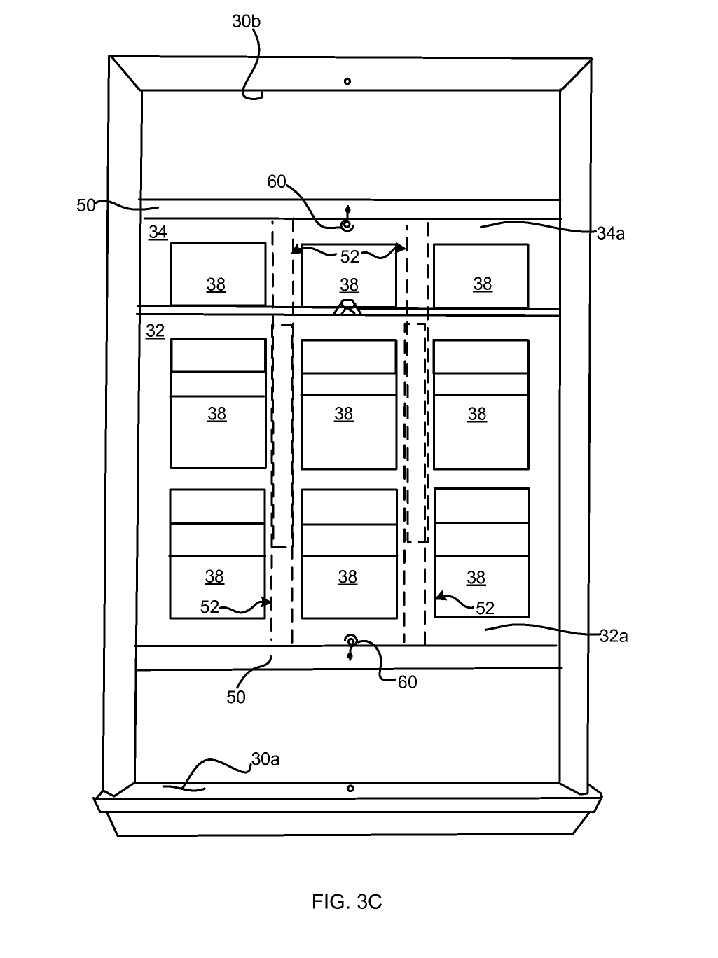

Referring now to FIGS. 3A-3C, there is shown another embodiment of the present invention, wherein both of the upper and lower sashes 32, 34 slide, and wherein each sash 32, 34 includes a security bar assembly, such as the security bar assembly 55 of FIG. 4. The security bar assembly of the upper sash 34 operates in all respects like the mirror image of the security bar assembly described in connection with FIGS. 2A-2C, 4 and 4A. For example, the security bar assembly of the upper sash 34, like that of the lower sash 32, includes security bars 52 secured to a base 50. The security bars 52 of both sashes 32, 34 are received in channels (42 of FIGS. 4 and 4a) in the vertical (or, for horizontally sliding sashes, horizontal) muntins 40a of the upper and lower sashes 32, 34. As with the embodiment of FIGS. 2A-2C, in the present preferred embodiment, the channels 42 are blind channels formed or made in the muntins 40, to which access is provided by holes formed through the bottom face of the lower rail 32a, for the lower sash 32, and the upper face of the upper rail 34a, for the upper sash 34.

One or both of the sashes 32, 34, may, optionally, include a latch 60 to secure the window security bar assembly of the respective sash 32, 34, to either a rail on the sash 32, 34, or to the casement 30. For example, as described above in connection with FIGS. 2A-2C, the latch 60 of the lower sash 32 can engage a mating part 62, such as an eyelet or projection on the rail 32a of the lower sash to secure the base 50 to the lower sash 32 (FIGS. 2A, 2C, 3A, 3C). Alternately, the latch 60 of the lower sash 32 can pivot about the pivot point 60a to engage a mating part 64 on the sill 30a and secure the base 50 to the window sill 30a (FIGS. 2B and 3B). Similarly, the latch 60 of the upper sash 34 operates in opposite fashion to secure the base 50 of the upper security bar assembly to either the upper rail 34a of the upper sash 34, or to the head jam 30b of the casement 30.

In this way, when both sashes are closed, the security bar assemblies of the upper and lower sashes 32, 34 are hidden from view, as they are entirely received within the channels 42 inside of the vertical muntins 40a. The security bars 52 of either sash 32, 34 are only visible when the respective sash 32, 34 has been moved to the open position, while the base 50 remains against the casement 30 (i.e., the sill 30a for the lower sash and the head jamb 30b for the upper sash).

Additionally, if desired, one or both of the the security bar assemblies of the upper and lower sashes 32, 34 may, themselves, slide, with the bars being fully received within the sashes 32, 34, as shown more particularly in FIG. 3C, with the base 50 of the lower sash 32 seated against, and/or latched to, the lower rail 32a of that sash and with the base 50 of the upper sash 34 seated against, and/or latched to, the upper rail 34a of the upper sash 34. In this position, the bars 52 are again hidden from view by being received within the vertical muntins 40a of the upper and lower sashes 32, 34 (i.e., preferably, coaxial with each muntin). Thus, the window may be fully opened to permit ingress and egress through the windows, for example, in the case of an emergency.

The present disclosure is provided to allow practice of the invention, after the expiration of any patent granted hereon, by those skilled in the art without undue experimentation, and includes the best mode presently contemplated and the presently preferred embodiment. Nothing in this disclosure is to be taken to limit the scope of the invention, which is susceptible to numerous alterations, equivalents and substitutions without departing from the scope and spirit of the invention.

1. A security bar system for a window, comprising:
a window sash, including:
a frame;
a plurality of glass panes arranged in said frame separated from one another by a plurality of muntins;
at least one muntin of said plurality of muntins including a channel formed therein, said channel being accessible from outside of said frame through a hole in said frame;
a security bar assembly, including:
a base configured to;
at least one security bar secured to said base;
said at least one security bar being slideably received within said channel of said at least one muntin; and
wherein said security bar assembly is configured to slide within a casement of the window while said at least one security bar is received within said at least one channel.

2. The security bar system of claim 1, wherein said at least one security bar is a plurality of security bars secured to said base and said at least one muntin is two or more muntins including a channel accessible through said frame, each security bar of said plurality of security bars being slideably received in exactly one channel of said two or more muntins.

3. The security bar system of claim 2, wherein each of said two or more muntins has only one channel.

4. The security bar system of claim 2, wherein said two or more of said muntins including a channel are vertical muntins.

5. The security bar system of claim 1, wherein said window sash and said security bar assembly are sized to be received inside of a casement of the window.

6. The security bar system of claim 5, wherein said security bar assembly includes a latch to secure said base to a portion of said casement.

7. The security bar system of claim 1, wherein said security bar assembly includes a latch to secure said base to a portion of a casement of the window.

8. The security bar system of claim 1, wherein said security bar assembly includes a latch to secure said base to a portion of said frame.

9. (canceled)

10. A window, comprising:
a casement;
a first window sash;
a second window sash, said first window sash sliding in said casement relative to said second window sash;
said first window sash including:
a frame;
a plurality of glass panes arranged in said frame separated by a plurality of muntins;
at least one muntin of said plurality of muntins including a channel formed therein, said channel being accessible from outside of said frame through a hole in said frame;
a security bar assembly, including:
a base;
at least one security bar secured to said base;
said at least one security bar being slideably received within said channel of said at least one muntin; and
said security bar assembly is configured to slide within said casement while said at least one security bar is received within said at least one channel.

11. The window of claim 10, wherein said at least one security bar is a plurality of security bars secured to said base and two or more of said muntins include a channel accessible through said frame, each security bar of said plurality being slideably received in exactly one channel of said two or more of said muntins.

12. The window of claim 10, wherein said second window sash includes:
a frame;
a plurality of glass panes arranged in said frame of said second window sash separated by a plurality of muntins;
at least one muntin of said plurality of muntins including a channel formed therein, said channel being accessible from outside of said frame through a hole in said frame of said second window sash;
and the window further includes:
a second security bar assembly, including:
a base;
at least one security bar secured to said base; and
said at least one security bar of said second security bar assembly being slideably received within said channel of said at least one muntin of said second window sash.

13. The window of claim 12, wherein said at least one security bar of each of said security assembly and said second second security assembly is a plurality of security bars secured to the base of each of said security assembly and said second security assembly, and two or more of said muntins of each of said first window sash and said second window sash include a channel accessible through said frame, each security bar of said plurality being slideably received in exactly one channel of said two or more of said muntins.

14. The window of claim 10, wherein said first sash slides vertically within said casement and said muntin is a vertical muntin.

15. (canceled)

16. A method of making a security bar system comprising:
providing a window sash, including:
a frame;
a plurality of glass panes arranged in the frame separated from one another by a plurality of muntins;
at least one muntin of the plurality of muntins including a channel formed therein, the channel being accessible from outside of the frame through a hole in the frame;
providing a security bar assembly, including:
a base; and
at least one security bar secured to the base; and
aligning a free end of the at least one security bar with the hole in the frame;
slideably receiving said free end of said at least one security bar through the hole, and into the channel; and
configuring the security bar assembly to slide within a casement of the window while the at least one security bar is received within the channel.

17. The method of claim 16, wherein the at least one security bar is a plurality of security bars secured to the base and two or more of the muntins include a channel accessible through the frame, each security bar of the plurality being aligned with a hole in the frame in the aligning step and slideably received in exactly one channel of the two or more muntins in the receiving step.

18. The method of claim 16, wherein the channel has a circular cross-section.
